(19) United States
(12) Patent Application Publication
(10) Pub. No.: US 2024/0296198 A1
(43) Pub. Date: Sep. 5, 2024

(54) SYSTEM AND METHOD FOR BUILDING INTERACTIVE AND DYNAMIC NATIVE RICH MULTIMEDIA CONTENT

(71) Applicant: Somplo LTD., Petah Tikva (IL)

(72) Inventor: Nadav Matz, Rosh HaAyin (IL)

(21) Appl. No.: 18/116,330

(22) Filed: Mar. 2, 2023

(51) Int. Cl. G06F 16/957

(52) U.S. Cl. CPC G06F 16/9577

(57) ABSTRACT

The subject matter discloses a computer-implemented method, comprising generating interactive and dynamic rich multimedia content, the multimedia content comprises interactive and dynamic element, and a native element. Extracting a style of the web page, applying the style only on the native element and presenting the multimedia content on a content area of the web page.

### FIELD OF THE INVENTION

The present disclosure relates to multimedia content in general, and to rich native media content, in particular.

### BACKGROUND OF THE INVENTION

Native multimedia content is a third-party multimedia content that is displayed on hosting website and it's text and background, fonts, or any style properties make its appearance to look like the hosting website. Clicking on an element of the native multimedia content redirects the user from the hosting website to the 3rd party website.

The domain of the third-party website is different than the domain of the hosting website and typically belongs to a third party.

### SUMMARY OF THE INVENTION

The term computing device refers herein to a device that includes a processing unit. Examples for such device are a personal computer, a laptop, a server, a wearable device, a tablet a cellular device and IOT (internet of things) device.

The term multimedia content refers herein to content that is playable on multimedia. Examples are to audio file, a video file, an image, a 3D object and image sequence. Example of video file format is the MP4 file format. The term interactive and dynamic element refers herein to an element of a rich multimedia content that allows the user to perform operations for changing its properties while the element is being displayed. Such operations can be, for example, rotate, resize, move etc.

The term rich multimedia content refers herein to a combination of multimedia content files.

The term content area refers herein to an area in the WEB page where native content is presented.

The term native element refers herein to an element that is designed to inherit the same style as the style of the hosting web page. The native element is typically text and title as depicted in FIG. 4.

The term interactive and dynamic native rich multimedia content refers herein to rich multimedia content that includes interactive and dynamic elements and native elements. The interactive and dynamic native rich multimedia content is designed to be presented in a content area. The domain of the code that implements the interactive and dynamic native rich multimedia content is different from the domain of the host page.

In some aspects of the present invention relates to a non-transitory computer-readable medium comprising instructions which when executed by at least one processor causes the processor to perform the method of the present invention.

One technical problem dealt with by the present disclosure is how to generate a dynamic and interactive native rich multimedia content.

One technical solution is generating multimedia content, the multimedia content comprises interactive and dynamic element, and a native element. Extracting a style of the web page, applying the style only on the native element and presenting the multimedia content on a content area of the web page.

Embodiments of the invention provide a computer implemented method the method comprises: combining and an at least one interactive and dynamic element and an at least one native element into interactive and dynamic native rich multimedia content; and as a result of accessing a web host page by a user, extracting a style of the host web page and applying the style only on the at least one native element for allowing the presenting of the interactive and dynamic native rich multimedia content on a content area of the host page; wherein the interactive and dynamic native rich multimedia content is associated with a first domain and the host page being associated with a second domain. According to some embodiments the native element comprises text or title. According to some embodiments the interactive and dynamic element being configured for changing one or more property as a result of an operation of the user and while the multimedia content being displayed.

Embodiments of the invention may be implemented as a computer process (method), a computing system, or as an article of manufacture, such as a computer program product or a non-transitory computer-readable media. The computer program product may be a computer storage media readable by a computer system and encoding a computer program of instructions for executing a computer process on the computer and network devices. The computer program product may also be a propagated signal on a carrier readable by a computing system and encoding a computer program of instructions for executing a computer process.

In some aspects of the present invention relates to a non-transitory computer-readable medium comprising instructions which when executed by at least one processor causes the processor to perform the method of the present invention.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of an environment for building interactive and dynamic native rich multimedia content, in accordance with some exemplary embodiments of the subject matter;

FIG. 2 shows a flowchart diagram of a method for generating interactive and dynamic native rich multimedia content, in accordance with some exemplary embodiments of the subject matter;

FIG. 3 shows a flowchart diagram of a method for activating interactive and dynamic rich native multimedia content, in accordance with some exemplary embodiments of the subject matter;

FIG. 4 shows a screenshot of an interactive and dynamic native rich multimedia content, in accordance with some embodiments of the disclosed subject matter; and

FIG. 5 shows a screenshot of a web page that includes interactive and dynamic native rich multimedia content, in accordance with some embodiments of the disclosed subject matter.

### DETAILED DESCRIPTION

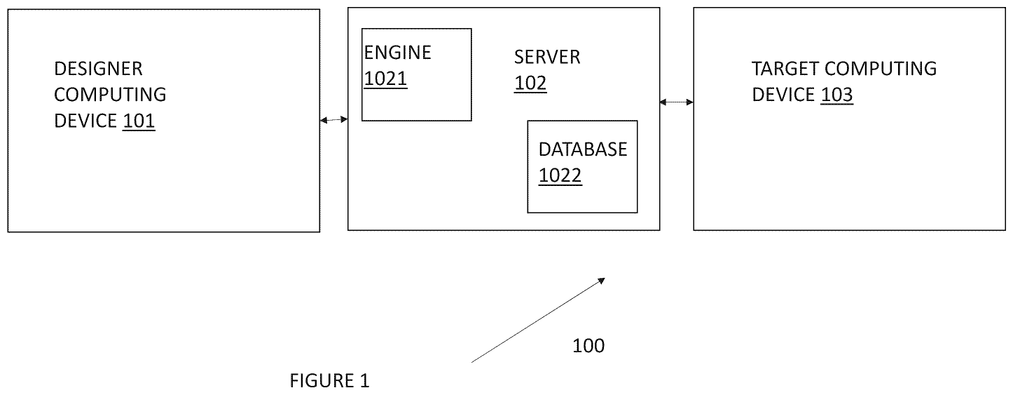

FIG. 1 shows a block diagram of an environment for building interactive and dynamic native rich multimedia content, in accordance with some exemplary embodiments of the subject matter.

Environment 100 includes a designer computing device 101, a server 102 and a target computing device 103.

The server 102 is configured for uploading multimedia content files from the designer computing device 102 and for changing properties of the rich media content upon a request from the designer.

The server 102 includes an engine 1021. Engine 1021 is configured for receiving requests from a designer for selecting one or more multimedia files. Engine 1021 is further configured to combine the multimedia files into code that creates the rich media content and interactive and dynamic objects. The code may be written for example in HTML, Java Scripts or CSS (Cascading Style Sheets).

The engine 1021 is further configured for changing the properties of the rich media content and of the interactive and dynamic elements according to requests from the designer. Examples of such properties are position size and code. The changing of the properties is performed by changing the code.

The server 102 further includes a database 1022. The database 1022 is further configured for storing the multimedia files, the dynamic and interactive objects and the rich media content.

The designer computing device 101 is configured for receiving requests from the designer and for transmitting the requests to the server 102.

The target computing device 103 is configured for displaying the rich native multimedia content in the content area of the web page, for receiving requests from the user for interacting with the rich multimedia content and for performing the dynamic changes in the interactive and dynamic elements.

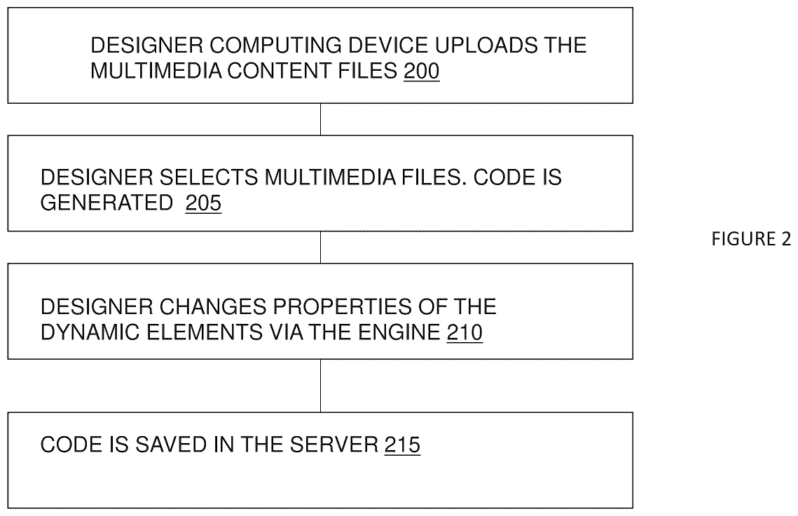

FIG. 2 shows a flowchart diagram for generating interactive and dynamic rich media content, in accordance with some exemplary embodiments of the disclosed subject matter.

At block 200 the designer computing device uploads the multimedia content files to the server. The designer (user) inputs the natives elements such as titles, description and images.

At block 205 the designer selects multimedia files for generating the multimedia content. As a result, the engine combines the files and the native elements into code that creates interactive and dynamic elements.

According to some embodiments there is provided a certain piece of code per each property of the interactive and dynamic element. The system selects the one or more pieces of code that are associated with the properties of the interactive element. The code can be, for example, HTML, JAVA script or CSS.

At block 210 the designer changes properties of the dynamic elements via the engine. Such properties can be positions, size, color etc. As a result, the system replaces the existing piece of code with the piece of code that is associated with the selected property.

At block 215 the code is saved in the server.

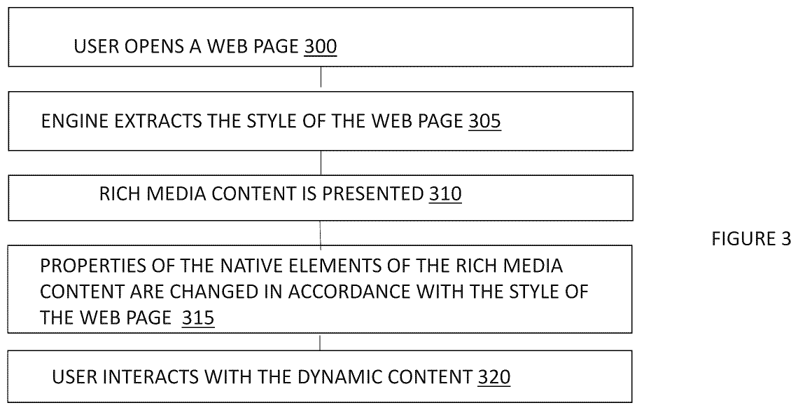

FIG. 3 shows a flowchart diagram of a method for activating interactive and dynamic native rich multimedia content, in accordance with some exemplary embodiments of the subject matter.

At block 300 the user opens a hosting webpage. As a result, the code of the interactive and dynamic native rich multimedia content, and the engine are downloaded to the target computing device.

At block 305, the engine extracts or inherits the style of the hosting web page. In one example the CSS style sheet is retrieved. The style sheet may be retrieved with JavaScript code or server-side scraping or can be inherited from the web site.

At block 310 the interactive and dynamic native rich multimedia content is presented on the content area of the hosting web page.

At block 315 the engine combines the extracted style of the web page with the interactive and dynamic native rich multimedia content such that the properties of the native elements are changed in accordance with the style of the web page while the properties of the interactive and dynamic elements are not changed.

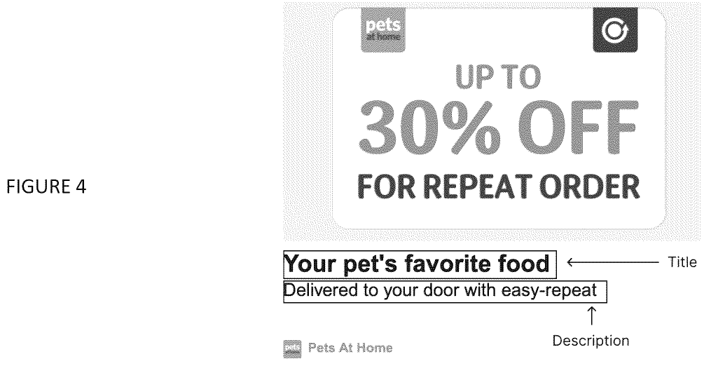

At block 320 the user interacts with the interactive and dynamic elements. FIG. 4 shows a screenshot of an interactive and dynamic native rich multimedia content, in accordance with some embodiments of the disclosed subject matter.

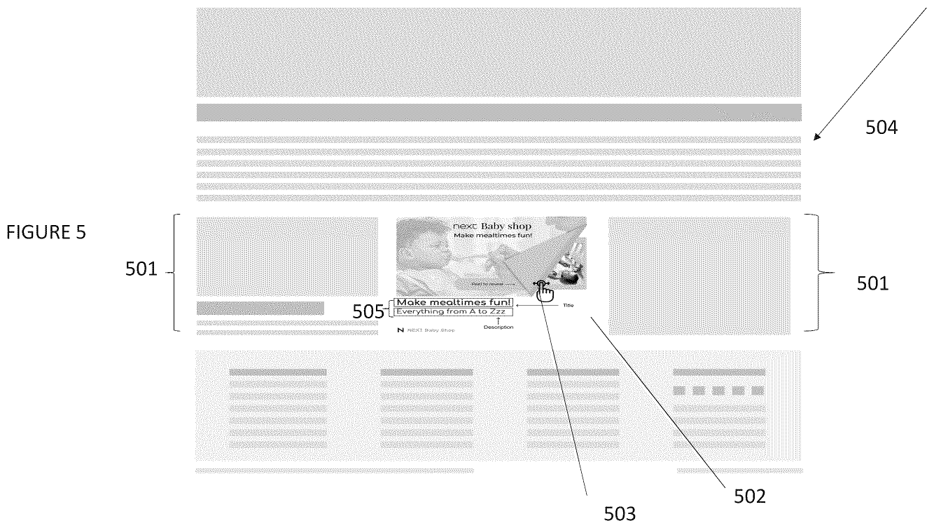

FIG. 5 shows a screenshot of a web page that includes interactive and dynamic native rich multimedia content, in accordance with some embodiments of the disclosed subject matter.

Web page 504 includes interactive and dynamic native rich multimedia content 502 within the content area 501. The interactive and dynamic native rich multimedia content 502 includes native element (title and description) 505 and an interactive and dynamic element 503.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that, in some alternative implementations, the functions noted in the block of a figure may occur out of the order noted in the figures. For example, two blocks shown in succession may, in fact, be executed substantially concurrently, or the blocks may sometimes be executed in the reverse order, depending upon the functionality involved.

What is claimed is:

1. A computer implemented method the method comprises:
combining an at least one interactive and dynamic element and an at least one native element into an interactive and dynamic native rich multimedia content; wherein said interactive and dynamic native rich multimedia content being associated with a first domain and wherein a host page hosting said interactive and dynamic native rich multimedia content being associated with a second domain; wherein said native element being designed to inherit a style of said host page; and
as a result of accessing said host web page by a user, extracting a said style of said host page and applying said style only on said at least one native element for presenting said interactive and dynamic native rich multimedia content on content area of said host page such that only said native element being presented in said style of said host page.

2. The method of claim 1 wherein said native element comprises text or title.

3. The method of claim 1 wherein said interactive and dynamic element being configured for changing one or more property as a result of an operation of the user and while said multimedia content being displayed.

4. A non-transitory computer-readable storage medium storing instructions, the instructions cause the processor to combining an at least one interactive and dynamic element and an at least one native element into an interactive and dynamic native rich multimedia content; wherein said interactive and dynamic native rich multimedia content being associated with a first domain and wherein a host page hosting said interactive and dynamic native rich multimedia content being associated with a second domain; wherein said native element being designed to inherit a style of said host page; and
as a result of accessing said host web page by a user; extracting said style of said host page and applying said style only on said at least one native element for presenting said interactive and dynamic native rich multimedia content on content area of said host page such that only said native element being presented in said style of said host page.

5. The method of claim 1 wherein said combining said at least one interactive and dynamic element and said at least one native element into said interactive and dynamic native rich multimedia content being performed by generating a software by a designer computing device and further comprising as a result of said accessing said host web page by said user; downloading said software code from said designer computing device to a computing device associated with said user for presenting said interactive and dynamic native rich multimedia content in a content area of said host page.
